(19) United States
(12) Patent Application Publication
(10) Pub. No.: US 2010/0321277 A1
(43) Pub. Date: Dec. 23, 2010

(54) HMD SYSTEM AND DISPLAY METHOD FOR AN HMD SYSTEM

(75) Inventors: Bernd Spruck, Moegglingen (DE); Simon Brattke, Oberkochen (DE)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: CARL ZEISS AG, Oberkochen (DE)

(21) Appl. No.: 12/446,078

(22) PCT Filed: Aug. 22, 2007
(86) PCT No.: PCT/EP2007/007396

§ 371 Date: Apr. 17, 2009

(30) Foreign Application Priority Data
Oct. 25, 2006 (DE) 10 2006 050 315.5

(51) Int. Cl. G09G 5/00

(52) U.S. Cl. 345/8

(57) ABSTRACT

An HMD system including an image data module, which includes an enabling unit and a data unit, as well as a display module that can be mounted on the head of a user and is connected to the image data module via a bidirectional communication channel. The enabling unit transmits an enabling request to the display module via the communication channel, and the display module transmits an enabling code via the communication channel in response to the enabling request. The enabling unit verifies the validity of the enabling code, prevents transmission of image data from the data unit to the display module if an invalid enabling code is present and allows transmission of image data from the data unit to the display module if a valid enabling code is present. The display module presents an image based on the transmitted image data to the user wearing the display module on his head.

### PRIORITY CLAIM

The present application is a National Phase entry of PCT Application No. PCT/EP2007/007396, filed Aug. 22, 2007, which claims priority from German Application Number 102006050315.5, filed Oct. 25, 2006, the disclosures of which are hereby incorporated by reference herein in their entirety.

### FIELD OF THE INVENTION

The present invention relates to a Head Mounted Display (HMD) system, comprising an image data module as well as a display module that can be mounted on the head of a user and is connected to the image data module via a bidirectional communication channel.

### BACKGROUND OF THE INVENTION

The image data module usually comprises software which provides the image data to the display module via the bidirectional communication channel. In many cases, the software is protected against unauthorized copying or use of such copies. For example, a so-called hardware dongle is provided which is to be connected to an interface of the computer on which the software runs. The software can be executed only if the hardware dongle is connected to the computer.

In addition to the software, the display module is an essential component of the HMD system, and it is the wish of HMD system manufacturers that the image data of the image data module should be displayable only by means of the display module of their own HMD systems.

### SUMMARY OF THE INVENTION

Therefore, it is an object of the invention to provide an HMD system, which comprises an image data module and a display module and ensures that the image data of the image data module can be displayed only by means of the display module.

The object is achieved by an HMD system comprising an image data module, which includes an enabling unit and a data unit, as well as a display module that can be mounted on the head of a user and is connected to the image data module via a bidirectional communication channel, wherein the enabling unit transmits an enabling request to the display module via the communication channel; the display module transmits an enabling code via the communication channel in response to the enabling request; the enabling unit verifies the validity of the enabling code, prevents transmission of image data from the data unit to the display module if an invalid enabling code is present and allows transmission of image data from the data unit to the display module if a valid enabling code is present, and the display module presents an image based on the transmitted image data to the user wearing the display module on his head.

Thus, it is possible to ensure that the image data of the image data module are displayed only by means of the (authorized) display module. Accordingly, display modules from other manufacturers cannot be used in the HMD system according to the invention.

The communication channel may be realized by any suitable connection between the image data module and the display module. If the image data module is provided as software that runs on a conventional computer, the VGA interface of the computer or the USB interface of the computer may be used, for example, to establish a connection to the display module by a corresponding cable.

In the HMD system, the enabling unit may carry out verification of the validity of the enabling code only after a predetermined first period has passed since transmission of the enabling request and may allow transmission of the image data from the data unit to the display module during said first period. Thus, it is possible to display the image already during said first period. The first period may also be used, for example, to display image data in a demonstration mode.

Further, the enabling unit may transmit the enabling request only after a second predetermined period has passed since a point in time which can be defined by the user and may allow transmission of the image data from the data unit to the display module during said second period. The user may define the point in time, for example, by activating the system.

The display module may verify the validity of the received enabling request, transmit the enabling code only if a valid enabling request is present, and deactivate itself, in the case of an invalid enabling request, such that no image can be presented. This has the effect that the display module can only display data of the image data module.

The enabling unit may block the communication channel for a third predetermined period if an invalid enabling code is present. This is advantageous in order to prevent unauthorized display of the image data (i. e. using a different display module).

After the third period has passed, the enabling unit may transmit a further enabling request to the display module via the communication channel, which display module transmits a further enabling code in response, which the enabling unit verifies, and if an invalid further enabling code is present, the enabling unit blocks the communication channel for a fourth predetermined period which is longer than the third predetermined period, and if a valid further enabling code is present, the enabling unit allows transmission of image data from the image data unit to the display module. The renewed and longer blocking of the communication channel makes it extremely difficult and time-consuming for the user to display image data of the image data module by an unauthorized display module.

In the HMD system, the enabling unit may allow image data transmission only for a fifth predetermined period if a valid enabling code is present. For example, this allows to realize a demonstration mode. It is also possible, after renewed transmission of an enabling request and the positive verification of the enabling code transmitted in response, to allow image transmission for a further predetermined period, so that it is continuously verified whether the authorized display module is still connected to the image data module via the communication channel.

The enabling unit may further include and/or be able to generate a multiplicity of different enabling requests, and the display module may include and/or generate a valid enabling code for each of the enabling requests. Thus, greater safety is achieved because there is a continuous transmission of different enabling requests and different enabling codes.

The enabling request and/or the enabling code may be transmitted in encrypted form.

Further, a display method for an HMD system is provided, said system comprising an image data module, which includes an enabling unit and a data unit, as well as a display module that can be mounted on the head of a user and is connected to the image data module via a bidirectional communication channel, wherein the enabling unit transmits an enabling request to the display module via the communication channel; the display module transmits an enabling code via the communication channel in response to the enabling request; the enabling unit verifies the validity of the enabling code, prevents transmission of image data from the data unit to the display module if an invalid enabling code is present and allows transmission of image data from the data unit to the display module if a valid enabling code is present, and the display module presents an image based on the transmitted image data to the user wearing the display module on his head.

This display method advantageously allows to display the image data of the image data module only by means of the display module that is authorized to do so.

In the method, the enabling unit may carry out verification of the validity of the enabling code only after a first predetermined period has passed since transmission of the enabling request and may allow transmission of the image data from the data unit to the display module during said first predetermined period. It is further possible that the enabling unit transmits the enabling request only after a second period has passed since a point in time which the user can define and that the enabling unit allows transmission of the image data from the data unit to the display module during said second period. These steps advantageously allow, for example, to realize a demonstration mode, in which image data of the image data module can already be displayed by means of the display module for a certain period (first or second predetermined period, respectively).

In the method, the display module may verify the validity of the received enabling request, transmit the enabling code only if a valid enabling request is present, and deactivate itself, in the case of an invalid enabling request, such that no image can be presented. This has the advantageous effect that the display module can display only the image data of the image data module.

The enabling unit may block the communication channel for a predetermined third period if an invalid enabling code is present. This makes it difficult for an attacker to get image data from the image data module.

In particular, the enabling unit may transmit a further enabling request to the display module via the communication channel after the third period has passed, which display module transmits a further enabling code in response, which the enabling unit verifies, and if an invalid further enabling code is present, the enabling unit blocks the communication channel for a fourth predetermined period, which is longer than the third predetermined period, and if a valid further enabling code is present, the enabling unit allows transmission of image data from the image data unit to the display module. The longer blocking in the case of an invalid enabling code makes it even more difficult for an attacker to get the image data of the image data module.

In the method, the enabling unit may allow image data transmission only for a fifth predetermined period if a valid enabling code is present. This allows, for example, to realize image display in a demonstration mode. Also, this procedure is suitable to carry out an authorization continuously (after the fifth predetermined period has passed), so that an exchange of the display module can be effectively prevented.

### BRIEF DESCRIPTION OF THE DRAWINGS

The invention will be described in more detail below, by way of example and with reference to the drawing, wherein:

FIG. 1 shows a schematic view of an embodiment of the HMD system according to an embodiment of the invention;

FIG. 2 shows a flow diagram explaining a mode of operation of the HMD system of FIG. 1;

FIG. 3 shows a further flow diagram explaining a further mode of operation of the HMD system of FIG. 1;

FIG. 4 shows a further flow diagram explaining a further mode of operation of the HMD system of FIG. 1, and

FIG. 5 shows a further flow diagram explaining a further mode of operation of the HMD system of FIG. 1.

### DETAILED DESCRIPTION

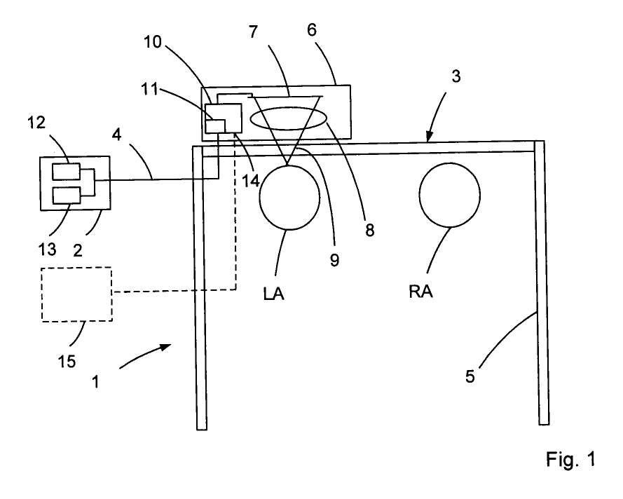

In the embodiment shown in FIG. 1, the HMD system 1 according to the invention comprises an image data module 2, as well as a display module 3 that is connected to the image data module 2 via a bidirectional communication channel 4.

The display module 3 comprises a head mount 5 in the form of a spectacle frame, as well as a display unit 6 mounted to the head mount 5 and comprising an image-generating element 7 (for example, an OLED module) for generating an image and imaging optics 8, by which the image generated by means of the image-generating element 7 is presented as a virtual image to a user wearing the display module 3. For the user, the left eye and the right eye, LA, RA, are schematically indicated. As is further evident from FIG. 1, the display unit 6 is provided for the left eye LA, which can perceive the virtual image (indicated in FIG. 1 by the visual field 9 of the left eye LA).

The display unit 6 further comprises control electronics 10 for controlling the image-generating element 7, said control electronics 10 including an enabling code section 11. The image data module 2, which serves to provide the image data and may be, for example, a conventional computer with suitable software, includes an enabling unit 12 as well as a data unit 13, which can communicate with each other, on the one hand, and are connected to the communication channel 4, on the other hand.

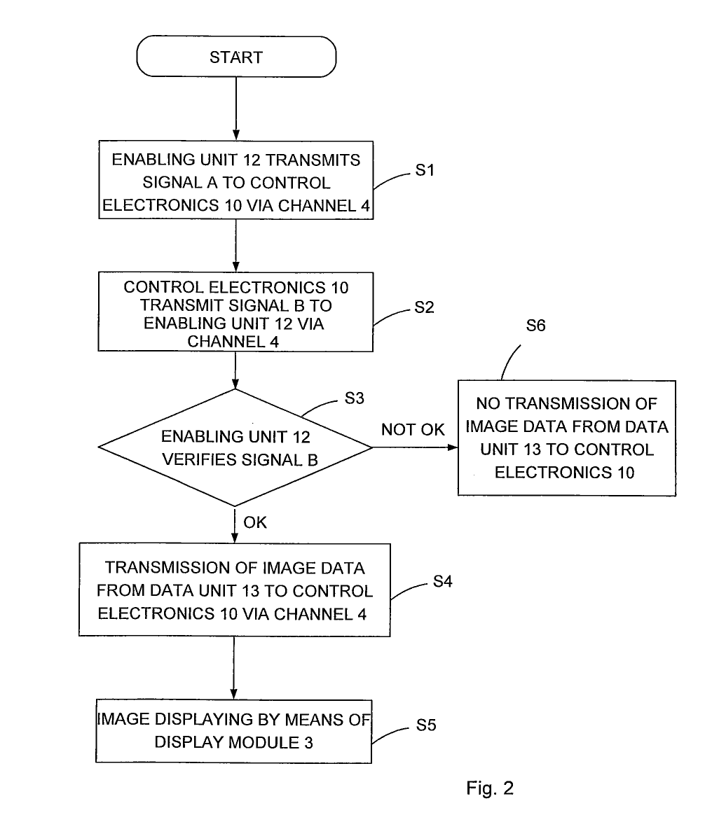

Now, if an image is to be displayed during operation, by means of the HMD system 1, to the user wearing the display module 3 on his head, the enabling unit 12 first transmits an enabling request (signal A) to the display module 3 or to the enabling code section 11, respectively, of the control electronics 10 via the communication channel 4 (step S1 of the flow diagram in FIG. 2).

The control electronics 10 or the enabling code section 11, respectively, transmit(s) an enabling code (signal B) to the enabling unit 12 of the image data module 2 via the communication channel 4 in response to the received signal A (step S2).

The enabling unit 12 verifies whether the received signal B is a valid enabling code (step S3). If the enabling code is valid, the enabling unit 12 allows transmission of image data from the data unit 13 to the control electronics 10 via the communication channel 4 (step S4).

The control electronics 10 can then control the image-generating element 7 on the basis of the received image data such that the desired image is generated (step S5).

If the enabling unit 12 determines in step S3 that the signal B is not a valid enabling code, it prevents transmission of image data from the data unit 13 to the display module 3 via the communication channel 4 (step S6). In order to be able to display image data by means of the display module 3, the process has to start with step 1 again. Step S6 may be further embodied such that this is possible only after a predetermined period (e.g. 1 minute). Further, step S6 may also be provided such that the length of the predetermined period is increased in the case of a renewed invalid verification (i.e. sequence of steps S1, S2, S3, S6).

This ensures that the image data of the image data module 2 are displayed only by means of an authorized display module 3.

The control electronics 10 of the display module 3 of the HMD system 1 shown in FIG. 1 comprise a further image data input 14 via which image data from a further image data source 15 (shown in broken lines) can be transmitted to the display module 3 and displayed by the display module 3. Thus, the display module 3 may preferably be provided such that, on the one hand, the image data of the image data module 2 can only be displayed if the display module 3 is authorized to do so. On the other hand, image data of a further image data source 15 can be displayed by the display module 3 without having to carry out steps S1-S3. This ensures that the image data of the image data source 2 can be displayed only by means of the display module 3 without limiting the functionality of the display module 3, because the display device 3 can continue to display image data from other sources.

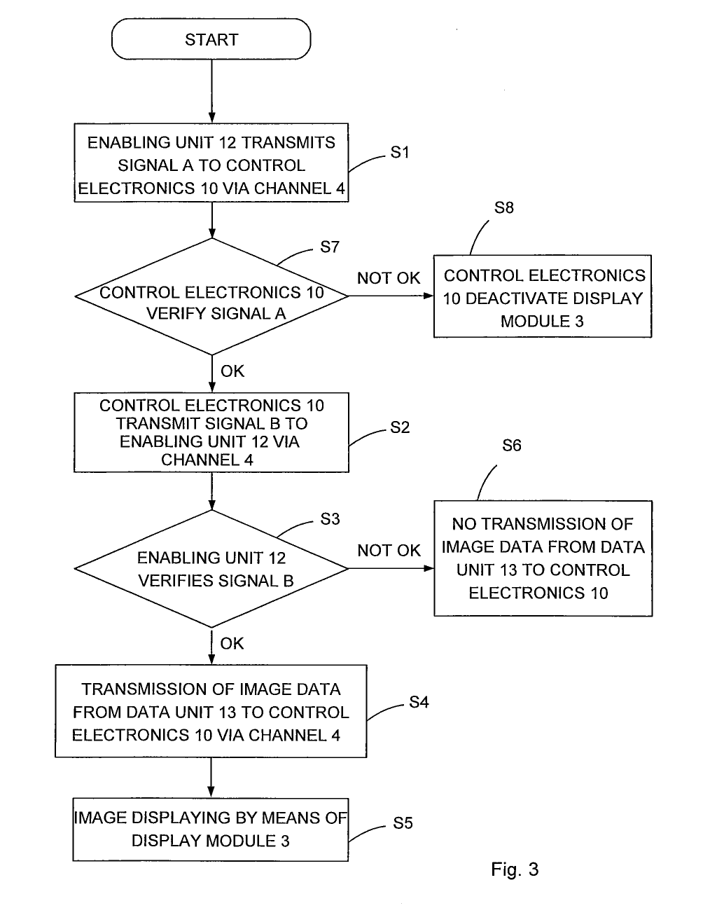

Of course, the display module 3 may also be provided such that it does not comprise the further image data input 14. In this case, operation may be modified such that a step S7 for verifying whether the signal A (enabling request of the enabling unit 12) is a valid signal is carried out between steps S1 and S2 (FIG. 3). If the signal is a valid signal, the process continues with step S2. If it is not a valid signal, the display module is deactivated in step S8 such that no images can be displayed by means of the display module 3.

Thus, this embodiment allows to ensure that the display module 3 is used only to display authorized image data of the image data module 2.

According to a modification, the signal A and/or the signal B may contain the information that image display is possible only for a predetermined period. After this period has passed, the process can branch from step S5 to step S6.

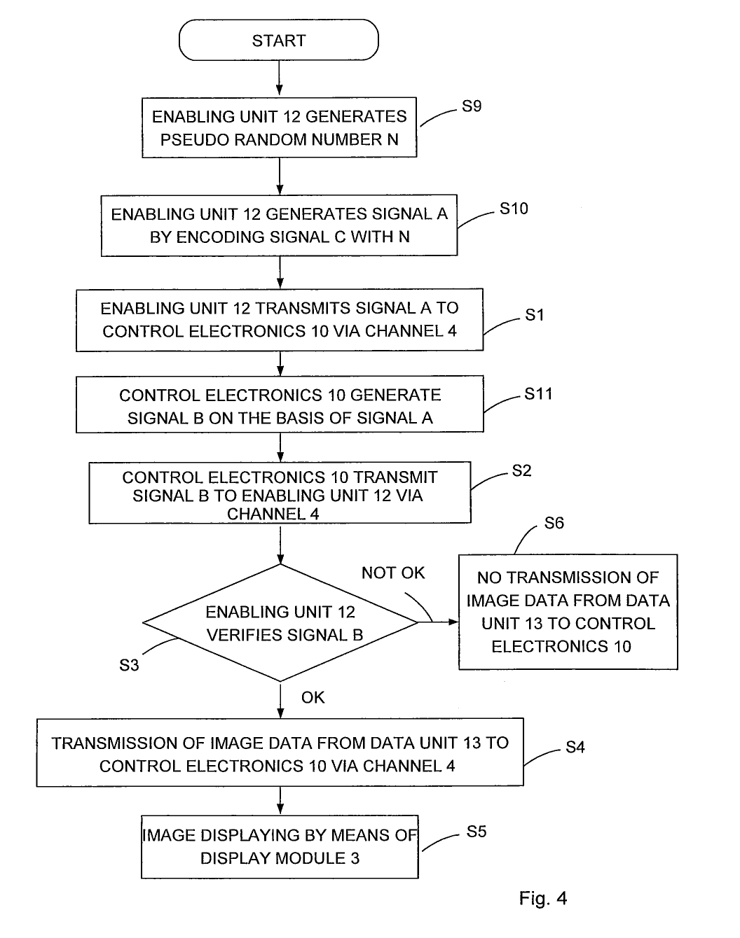

FIG. 4 shows a further modification of the flow diagram of FIG. 2, wherein, prior to transmission of the signal A, a pseudo random number N is generated in a step S9 and is used in step S10 to encode a signal C and, thus, to generate the signal A. The signal A is transmitted, via the communication channel 4, to the enabling code section 11 of the control electronics 10 in step S1. In step S11, the enabling code section 11 of the control electronics 10 uses the received signal C to generate a matching enabling code B, which is then transmitted to the enabling unit 12 in step S2. The remaining steps S3-S6 are the same as in the embodiment of FIG. 2.

These steps allow to generate different signals to be transmitted and, at the same time, to carry out the required authorization of the display module 3. In particular, the signal A or B, respectively, can be generated both on the side of the enabling unit 12 and on the side of the control electronics 10 by a mathematical pseudo code.

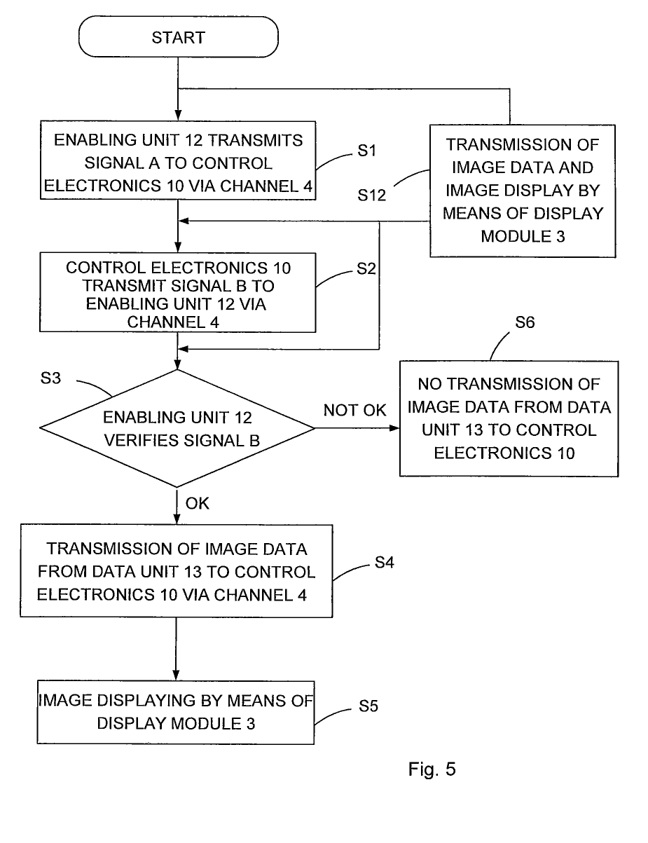

FIG. 5 shows a further modification of the process of FIG. 2. In this modification, image data are transmitted already after step S1 from the data unit 13 to the display module 3 via the communication channel 4 and displayed by means of the display module 3 (step S12). Step S12, however, is carried out only for a predetermined period (for example, for 3 minutes), and the process then branches back to step S2 or S3. Should no valid signal B be determined in step S3, image display is ended by interrupting the image data transmission.

The process of FIG. 5 can be modified such that it branches directly to step S6 after the predetermined period has passed, if steps S1 and S2 were not carried out during the predetermined period. Thus, the HMD system can be used only during the predetermined period, which may be useful, for example, in presentation systems.

The described embodiments and their individual steps may be combined with each other as desired.

In particular, the HMD system and especially the display module 3 may be provided such that images are presented to both eyes LA, RA of the user. In HMD systems, the image(s) is (are) preferably presented as a virtual image(s).

1. A head mounted display system, comprising:
an image data module, including an enabling unit and a data unit; and
a display module mountable on the head of a user and operably connected to the image data module via a bidirectional communication channel, the enabling unit adapted to transmit an enabling request to the display module via the communication channel;
wherein the display module is adapted to transmit an enabling code via the communication channel in response to the enabling request,
the enabling unit is adapted to verify the validity of the enabling code, preventing transmission of image data from the data unit to the display module if an invalid enabling code is present and to allow transmission of image data from the data unit to the display module if a valid enabling code is present, and
the display module is further adapted to present an image based on the transmitted image data to the user wearing the display module on his head.

2. The system as claimed in claim 1, wherein the enabling unit carries out the verification of the validity of the enabling code only after a first predetermined period has passed since transmission of the enabling request and allows transmission of the image data from the data unit to the display module during said first period.

3. The system as claimed in claim 1, wherein the enabling unit transmits the enabling request only after a second predetermined period has passed since a point in time capable of being defined by the user, and allows transmission of the image data from the data unit to the display module during said second period.

4. The system as claimed in claim 1, wherein the display module verifies the validity of the received enabling request, transmits the enabling code only if a valid enabling request is present, and deactivates itself, in the case of an invalid enabling request, so that no image can be presented.

5. The system as claimed in claim 1, wherein the enabling unit blocks the communication channel for a third predetermined period if an invalid enabling code is present.

6. The system as claimed in claim 5, wherein the enabling unit transmits a further enabling request to the display module via the communication channel after the third period has passed, the display module transmits a further enabling code in response to to the enabling request, said code being verified by the enabling unit, wherein, if an invalid further enabling code is present, the enabling unit blocks the communication channel for a fourth predetermined period that is longer than the third predetermined period, and if a valid further enabling code is present, the enabling unit allows transmission of image data from the image data unit to the display module.

7. The system as claimed in claim 1, wherein the enabling unit allows image data transmission only for a fifth predetermined period if a valid enabling code is present.

8. A display method for a head mounted display system, comprising:
providing an image data module, including an enabling unit and a data unit;
providing a display module mountable on a head of a user and connectable to the image data module via a bidirectional communication channel;
the enabling unit transmitting an enabling request to the display module via the communication channel;
the display module transmitting an enabling code via the communication channel in response to the enabling request;
the enabling unit verifying the validity of the enabling code, preventing transmission of image data from the data unit to the display module if an invalid enabling code is present and allowing transmission of image data from the data unit to the display module if a valid enabling code is present; and
the display module presenting an image based on the transmitted image data to the user wearing the display module on the head.

9. The method as claimed in claim 8, wherein the enabling unit verifying the validity of the enabling code comprises the enabling unit verifying the validity of the enabling code only after a first predetermined period has passed since transmission of the enabling request and wherein allowing transmission of the image data from the data unit to the display module comprises allowing transmission during said first period.

10. The method as claimed in claim 8, wherein the enabling unit transmitting the enabling request comprises the enabling unit transmitting the enabling request only after a second predetermined period has passed since a point in time capable of being defined by the user, and wherein allowing transmission of the image data from the data unit to the display module comprises allowing transmission during said second period.

11. The method as claimed in claim 8, further comprising the display module verifying the validity of the received enabling request, transmitting the enabling code only if a valid enabling request is present, and deactivating itself in the case of an invalid enabling request, so that no image can be presented.

12. The method as claimed in claim 8, further comprising the enabling unit blocking the communication channel for a third predetermined period if an invalid enabling code is present.

13. The method as claimed in claim 12, further comprising the enabling unit transmitting a further enabling request to the display module via the communication channel after the third period has passed; and
the display module transmitting a further enabling code in response to the further enabling request, said code being verified by the enabling unit, wherein, if the further enabling code is invalid, the enabling unit blocking the communication channel for a fourth predetermined period that is longer than the third predetermined period, and if the further enabling code is invalid, the enabling unit allowing transmission of image data from the image data unit to the display module.

14. The method as claimed in claim 8, wherein the enabling unit allowing image data transmission comprises allowing image data transmission only for a fifth predetermined period if a valid enabling code is present.

15. The method as claimed in claim 10, further comprising the user defining the point in time.

16. A display method for a head-mounted display system that includes an image data module with an enabling unit and a data unit, and a display module adapted for mounting on a head of a user, the method comprising:
transmitting an enabling request from an enabling unit of an image data module via a bidirectional communication channel to a display module adapted to be mounted on a head of a user;
receiving the transmitted enabling request at the display module;
transmitting an enabling code from the display module via the bidirectional communication channel in response to the enabling request;
verifying validity of the enabling code with the enabling unit;
preventing transmission of image data from a data unit of the image data module to the display module if the enabling code is invalid;
allowing transmission of the image data from the data unit to the display module if the enabling code is valid; and
presenting an image on the display module based on the image data, to the user wearing the display module on the head.

17. The method as claimed in claim 16, wherein verifying the validity of the enabling code comprises the enabling unit verifying the validity of the enabling code only after a first predetermined period of time has passed following transmission of the enabling request.

18. The method as claimed in claim 17, wherein transmitting the enabling request comprises the enabling unit transmitting the enabling request only after a second predetermined period of time has passed from a point in time defined by the user.

19. The method as claimed in claim 18, further comprising the enabling unit blocking the communication channel for a third predetermined period if the enabling code is invalid.

20. The method as claimed in claim 20, the method further comprising the enabling unit transmitting a further enabling request to the display module via the communication channel after a fourth predetermined time period has passed; and
the display module transmitting a further enabling code in response to the further enabling request, said code being verified by the enabling unit, wherein, if the further enabling code is invalid, the enabling unit blocking the communication channel for a fourth predetermined period that is longer than the third predetermined period, and if the further enabling code is valid, the enabling unit allowing transmission of image data from the image data unit to the display module.
